(19) United States
(12) Patent Application Publication
(10) Pub. No.: US 2003/0025950 A1
(43) Pub. Date: Feb. 6, 2003

(54) Contact type image sensor

(75) Inventor: Shiro Tsunai, Tokyo (JP)

Correspondence Address: YOUNG & THOMPSON, 745 SOUTH 23RD STREET 2ND FLOOR, ARLINGTON, VA, 22202

(73) Assignee: NEC CORPORATION, Tokyo (JP)

(21) Appl. No.: 10/196,240

(22) Filed: Jul. 17, 2002

(30) Foreign Application Priority Data
Aug. 2, 2001 (JP) 2001-235150

(51) Int. Cl. H04N 1/46

(52) U.S. Cl. 358/505

(57) ABSTRACT

A sensor chip arranged in a casing having a window portion on the side thereof to be faced to a medium to be read takes in the form of a single long chip. In particular, a single long and seamless sensor chip having a plurality of photoelectric conversion elements arranged thereon throughout a length of the window portion of the casing is mounted on a long supporting substrate having a length long enough to support the whole sensor chip. The sensor chip and the supporting substrate are bonded together such that transmission of stress due to external force exerted on the supporting substrate to the sensor chip is restricted.

### BACKGROUND OF THE INVENTION

1. Field of the Invention

The present invention relates to a contact type image sensor and, particularly, to a contact type image sensor for use in a scanner, a facsimile, a copier and the like.

2. Description of the Prior Art

A contact type image sensor of such as a scanner is usually constructed with photo diodes arranged to cover a full width of a medium such as an original to be read, without using a reducing glass for reducing an optical signal from the medium and focusing the reduced signal on the photo diodes.

Incidentally, the contact type image sensor can be made compact compared with the reducing lens type image sensor.

FIG. 1 is an illustrative plan view of an image pickup system of a conventional contact type image sensor. FIG. 2 shows, in an enlarge scale, a portion of the image pickup system shown in FIG. 1, which includes a plurality of sensor chips 4 thereof. Each sensor chip 4 is a semiconductor sensor chip such as a CCD including a plurality of photo diodes 11 arranged in a line. The semiconductor sensor chips 4 are arranged in a line on a sensor supporting substrate 5 in the form of such as a printed circuit board, as shown in FIG. 1. The supporting substrate 5 includes a driver IC, which is not shown and mounted thereon and the semiconductor sensor chips are connected to the driver IC through bonding wires, etc., which are not shown, through the printed circuit on the supporting substrate.

When the optical signal from the medium to be read is converted into electric signals by the photo diodes 11 and the sensor chips 4 are driven by the driver IC on the sensor supporting substrate 5, the electric signals are read out on the side of the sensor chips 4 and an image is formed of the medium is formed by processing the electric signals by a processing means, which is not shown.

However, since, in the prior art technology, a plurality of sensor chips are arranged on a sensor supporting substrate such as a printed circuit board, an interval of photo diodes in all of sensor chips on the supporting substrate is not constant due to a gap between adjacent sensor chips. In such case, it is impossible to obtain an image in areas between the sensor chips. Therefore, in order to interpolate the images to be obtained in these areas, it is necessary to perform interpolation by using the read out electric signals.

The photo diodes on the sensor chip can be made compact as mentioned previously. However, in order to perform the interpolation precisely, the size of photo diode must be made as small as the size of the gap between the adjacent sensor chips. Further, it is necessary to make the interval between adjacent photo diodes as small as the interval between the adjacent sensor chips. Consequently, it is impossible to improve resolution of the image sensor.

In concrete, it was difficult to obtain resolution of the image sensor, which is 1200DPI (48 dot/mm) or higher. Further, when a color separation filter is provided on the photo diode, resolution becomes as low as about 400DPI.

If the color separation filter is provided while sacrificing resolution, resolution is further lowered when a color original is read since the interval of the photo diodes is wide. Therefore, it is usual that monochromatic sensor chips are used, three primary color lights are emitted from red, green and blue light sources and an image in the same position is read by sequentially switching the three primary color lights.

Further, it is difficult to arrange a plurality of sensor chips in a straight line and, usually, there is a deviation of about ±0.2 mm. Therefore, the reading accuracy of image is degraded and, when a straight line on an original is read to form an image, the straight line in the image may be stepped.

In order to solve of the interval problem of the sensor chips, it may be considered to merely form a single long sensor chip. In the latter case, however, the long sensor chip may be broken when stress is exerted on the chip during an assembling step or after an image sensor is completed. Particularly, when a supporting substrate having a long sensor chip is assembled within a casing, an exertion of large external force on the supporting substrate is unavoidable. It is usual that the supporting substrate takes in the form of an epoxy resin based printed circuit board. Such supporting substrate tends to be easily deformed by external force and, therefore, possibility of breakage of sensor chips is high, resulting in reduced producibility of the image sensor.

### SUMMARY OF THE INVENTION

An object of the present invention is to provide a contact type image sensor having a sensor chip, which is unbreakable.

The contact type image sensor according to a first aspect of the present invention is featured by that an image sensor provided in a casing having a window portion in a wall facing to a medium to be read has a single long sensor chip. Particularly, the single sensor chip, which is long and seamless and has a plurality of photoelectric conversion elements arranged over the window portion of the casing, is mounted on a supporting substrate long enough to mount the single long sensor chip. The long sensor chip is bonded onto the supporting substrate such that transmission of external force exerted on the supporting substrate to the sensor chip is substantially reduced.

Preferably, the supporting substrate is formed of a highly rigid material. It may be possible to arrange a plate member having rigidity higher than that of the sensor chip between the supporting substrate and the sensor chip.

Further, it is preferable that the sensor chip is bonded to the supporting substrate by a flexible adhesive. Alternatively, it is possible to make the sensor chip more flexible than the supporting substrate by making the sensor chip thin.

The sensor chip according to the present invention may be formed of single crystal or polycrystal silicon. The photoelectric conversion elements may be arranged in delta form.

According to a second aspect of the present invention, the contact type image sensor is featured by a color separation filter arranged between the medium to be read and the photoelectric conversion elements. A rod lens for focusing an optical signal from the window portion of the casing onto the photoelectric conversion elements may be provided between the window portion and the sensor chip.

Particularly, the contact type image sensor according to a third aspect of the present invention is featured by comprising a plurality of photoelectric conversion elements for converting an optical signal from a medium to be read into electric signals, a single sensor chip for reading the electric signals converted by the photoelectric conversion elements or signals based on the electric signals and a circuit board having a driver and mounting the photoelectric conversion elements and the single sensor chip thereon.

### BRIEF DESCRIPTION OF THE DRAWINGS

FIG. 1 is an illustrative plan view of an image pickup system of a conventional contact type image sensor;

FIG. 2 shows, in an enlarge scale, a portion of the image pickup system shown FIG. 1;

FIG. 3 is a plan view of a contact type image sensor according to an embodiment of the present invention;

FIG. 4 is a cross section of the contact type image sensor, taken along a line A-A in FIG. 3;

FIG. 5 is a plan view of the contact type image sensor of the present invention, showing an example of the sensor chip 4 and a sensor supporting substrate 5;

FIG. 6 is a cross section of the contact type image sensor, taken along a line B-B in FIG. 3;

FIG. 7A is a plan view of the contact type image sensor of the present invention, showing another example of the sensor chip 4 and a sensor supporting substrate 5;

FIG. 7B is a plan view of the contact type image sensor of the present invention, showing an arrangement of a color separation filter corresponding to the sensor chip shown in FIG. 7A;

FIG. 8A is a cross section of the contact type image sensor of the present invention, showing an example of means for preventing the sensor chip from being broken;

FIG. 8B is a cross section of the contact type image sensor of the present invention, showing another example of means for preventing the sensor chip from being broken;

FIG. 9 is a cross section of a contact type image sensor according to another embodiment of the present invention; and

FIG. 10 is a cross section of a contact type image sensor having no rod lens.

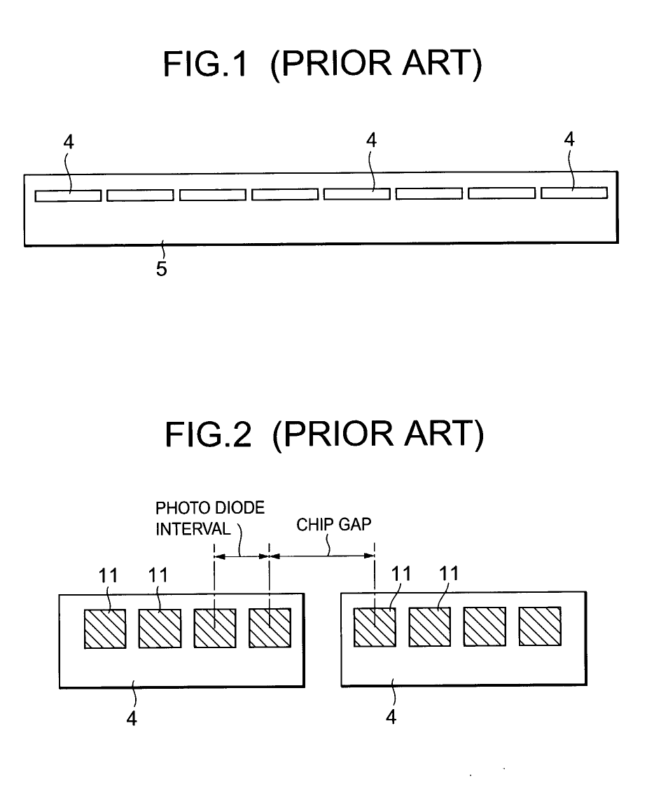

### DETAILED DESCRIPTION OF THE PREFERRED EMBODIMENTS

Preferred embodiments of the present invention will be described with reference to the drawings.

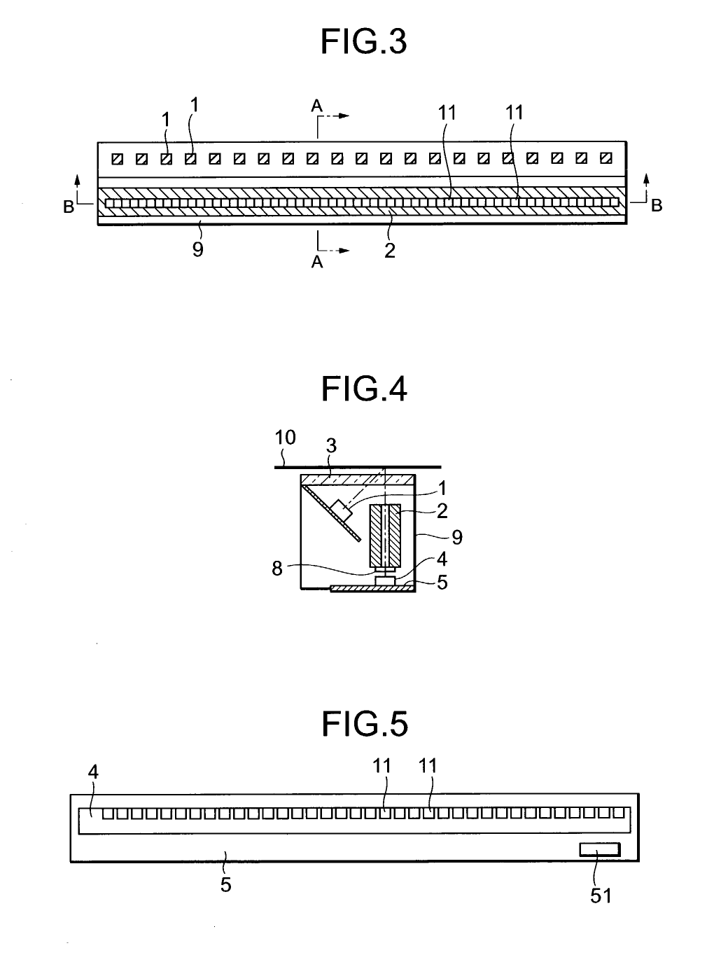

As shown in FIG. 3 and FIG. 4, the contact type image sensor according to a first embodiment of the present invention comprises a light emitting diode (LED) 1 as a light source, a rod lens 2 for condensing light from the LED1, a long and seamless single sensor chip 4 on which the light condensed by the rod lens 2 is focused, for reading resultant charges, a sensor supporting substrate 5 for supporting the sensor chip 4, a cover glass 3 for protecting the LED1 and the rod lens 2, etc., and supporting an original 10, which is a medium to be read, etc., and a casing 9 formed of a metal material or a resin material, etc.

As the photoelectric conversion elements, a plurality of photo diodes 11 are arranged in one line on the long sensor chip 4 at a constant interval, as shown in FIG. 5. The sensor supporting substrate 5 is a circuit board having a driver IC 51 for controlling driving of the sensor chip.

Incidentally, the sensor chip 4 has means for sequentially converting signal charges converted by the photo diodes 11 into voltages and reading the voltages. As such sensor chip 4, CCD image pickup elements or CMOS type image pickup elements may be used. Alternatively, photo transistors may be used in lieu of the photo diodes 11.

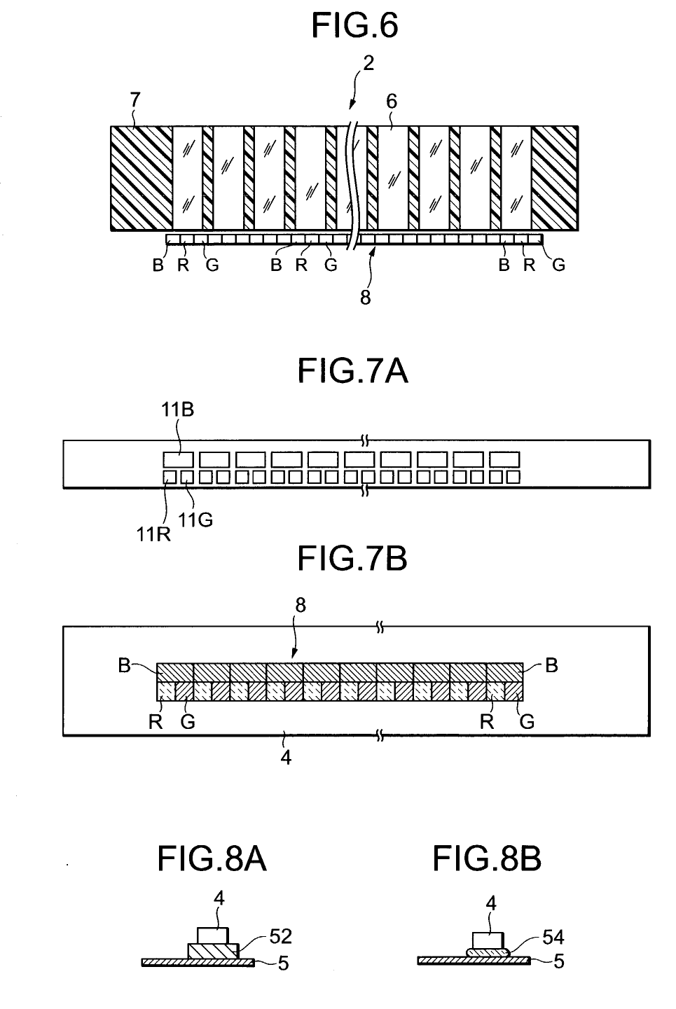

As shown in FIG. 6, the rod lens 2 includes a plurality of transparent fibers 6 such as optical fibers and a black colored fiber supporting resin 7.

Further, a color separation filter 8 for separating RGB colors is positioned between the photo diodes 11 and the rod lens 2. The color separation filter 8 is composed of a plurality of color filter groups each including three color filters RGB arranged in a line. Assuming the highest resolution of the photo diode is A (mm), a plurality of photo diode groups each including three of the photo diodes 11 correspondingly to the RGB color filters in each color filter group are arranged in lateral direction on the drawing sheet to form a rectangular photo diode arrangement having shorter side length A and longer side length A/3.

The arrangement of RGB color filters in the color separation filter 8 is coincident with the arrangement of the photo diodes. When the photo diodes are arranged on a straight line as shown in FIG. 5, the color filter groups each including RGB filters are arranged in a line as shown in FIG. 6.

Alternatively, when the photo diodes are arranged in a delta configuration as shown in FIG. 7A, the RGB color filters are arranged in a delta configuration correspondingly thereto as shown in FIG. 7B. Particularly, it is preferable that the photo diodes 11 below the respective filters allowing blue color light to pass through are made larger in size than the others. This is because level of signal charges from the photo diode 11 below the blue light passing filter is lower than levels of signal charges from other photo diodes below red or green passing filter and it is necessary to supplement the lower signal charge level for the blue color light passing filter.

However, since the level supplement of the signal charge can be done by a signal processing circuit on the side of the sensor supporting substrate 5, it is not always necessary to make the size of the photo diode below the blue light passing filter large compared with that of the photo diodes below the red and green light passing filters.

In addition to the driver IC 51 for driving the sensor chip 4, an amplifier for amplifying the signal charge outputted from the sensor chip 4, etc., may be mounted on the sensor supporting substrate 5 on which the sensor chip 4 is mounted.

In order to prevent the long sensor chip 4 from being broken, the sensor supporting substrate 5 is formed of ceramics to form the sensor supporting substrate as a ceramic circuit substrate, which is rigid enough to prevent the sensor chip from being bent. This is preferable as a construction for reducing external force exerted on the sensor chip 4.

As another measures against breakage of the long sensor chip, a plate member 52 such as a steel plate or a ceramic plate, which has a rigidity higher than that of the sensor chip, may be provided between the sensor chip 4 and the supporting substrate 5, as shown in FIG. 8A. In the latter case, it is preferable that the plate member 52 is longer and wider than the sensor chip 4 and shorter and narrower than the supporting substrate 5. The plate member 52 is preferably thicker than the sensor chip 4.

In the example mentioned above, the sensor chip 4 may be bonded to the supporting substrate 5 by an adhesive such as epoxy type adhesive or ultraviolet ray setting type adhesive, which is hardened after solidified. Alternatively, it has been found that breakage of the long sensor chip 4 can be prevented by providing a flexible shock-absorbing member 54. In the latter case, an adhesive used to bond the sensor chip 4 and the supporting substrate 5 to the shock-absorbing member 54 has high flexibility after solidified and can absorb bending stress of the supporting substrate. An example of such adhesive is silicon rubber.

Another means for preventing breakage of the sensor chip is to make the sensor chip 4 flexible by making the sensor chip 4 as thin as about 50 μm.

Further, according to the present invention, a contact type image sensor having reliability higher than that obtained by employing one of the described breakage preventing means is obtained by employing a combination of the described breakage preventing means. For example, a ceramic circuit board is used as the sensor supporting substrate and an adhesive functioning as a shock-absorbing member is used to bond the sensor chip to the substrate. In this example, it may be possible to insert a rigid plate such as a ceramic plate into between the sensor supporting substrate and the sensor chip.

In this embodiment, the single sensor chip 4 whose length is at least equal to the reading width of the original is provided on the sensor supporting substrate 5 and signal variation is prevented by providing the photo diodes 11 on the sensor chip 4 at a constant interval, as mentioned previously.

As to the reading width of the sensor chip 4, in order to read, for example, a shorter side (210 mm) of an A4 size original, the length of the sensor chip 4 should be 220 mm or more. By using a semiconductor wafer such as single crystal silicon wafer 10 inches (245 mm) long or more, it is possible to provide the sensor chip 4 capable of reading the A4 size original 10. In this connection, it is possible to provide a sensor chip having length nearly equal to 30 inches (735 mm) when polycrystal silicon wafer is used.

Further, when the interval of the photo diodes 11 on the sensor chip 4 is 4 μm, resolution thereof becomes 6250 DPI (250 dot/mm).

In a case where an information of a 21 mm×28 mm film as the original 10 is to be read, the length of the sensor chip 4 is made equal to the shorter side length of the film, that is, 21 mm. In such case, resolution thereof corresponds to 6250 DPI.

The contact type image sensor according to this embodiment is seamless. Therefore, there is no degradation of resolution even when small size photo diodes are used. Consequently, it becomes possible to read a color original all at once by arranging the small photo diodes 11 in a line and forming a three color filter of primary colors or complementary colors on the photo diodes 11.

In such case, the LED 1 to be used can emit red, green and blue lights simultaneously. Alternatively, a white light source such as a cold cathode ray tube or a fluorescent tube may be used in lieu of the LED.

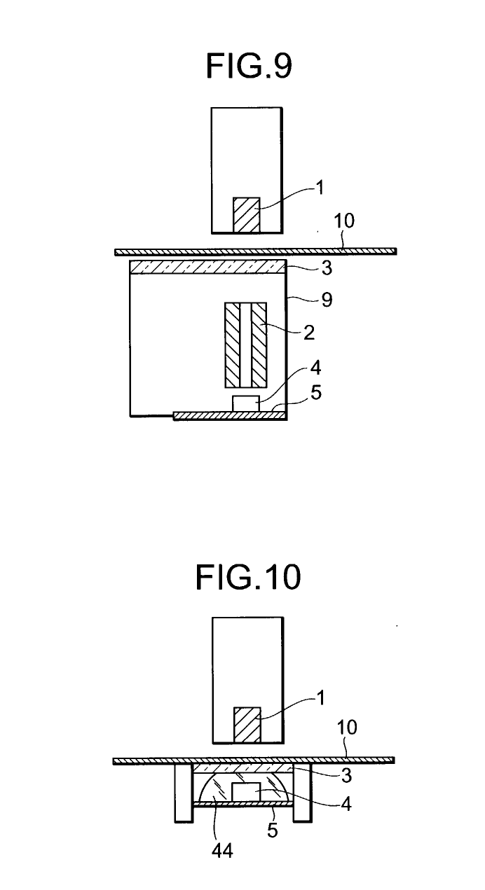

FIG. 9 corresponds to FIG. 4 and is a cross section of a contact type image sensor according to a second embodiment of the present invention. In FIG. 9, components similar to those shown in FIG. 4 are depicted by the same reference numerals as those used in FIG. 4, respectively.

As described with respect to the first embodiment, the contact type image sensor shown in FIG. 4 processes the reflected light from the original 10 on the side of the sensor chip 4 and the contact type image sensor shown in FIG. 8A or 8B processes the light passed through the original 10 on the side of the sensor chip. The sensor chip 4 of the contact type image sensor shown in FIG. 9 is similar to that shown in FIG. 5.

Incidentally, in the second embodiment, it is possible to connect a cover glass 3 to the sensor supporting substrate 5 having the sensor chip 4 formed thereon by a transparent resin 44 as shown in FIG. 10.

As described hereinbefore, according to the present invention, the sensor chip mounted on the supporting substrate is not influence of external force exerted on the supporting substrate in assembling the supporting substrate in the casing. Therefore, it is possible that the sensor chip is not broken even when the latter is long.

What is claimed is:

1. A contact type image sensor comprising:
a casing having walls, one of said walls being faced to a medium to be read and formed with a rectangular window;
a single long and seamless sensor chip arranged in said casing, said single long and seamless sensor chip having a plurality of photoelectric conversion elements arranged throughout a length of said rectangular window; and
a supporting substrate having a length large enough to support said sensor chip as a whole, said sensor chip and said supporting substrate being bonded together such that transmission of stress due to external force exerted on said supporting substrate to said sensor chip is reduced.

2. A contact type image sensor as claimed in claim 1, wherein said supporting substrate is formed of a rigid material.

3. A contact type image sensor as claimed in claim 1, further comprising a plate member having high rigidity and provided between said supporting substrate and said sensor chip.

4. A contact type image sensor as claimed in claim 1, wherein said sensor chip is bonded to said supporting substrate by a flexible adhesive.

5. A contact type image sensor as claimed in claim 1, wherein said sensor chip has flexibility higher than that of said supporting substrate.

6. A contact type image sensor as claimed in claim 1, wherein said sensor chip is formed of single crystal silicon or polycrystal silicon.

7. A contact type image sensor as claimed in claim 1, wherein said photoelectric conversion elements are arranged in delta formation.

8. A contact type image sensor as claimed in claim 1, further comprising a color separation filter provided between said medium to be read and said photoelectric conversion elements.

9. A contact type image sensor as claimed in claim 1, further a rod lens provided between said window portion and said sensor chip, for focusing an optical signal from said window portion on said photoelectric conversion elements.

10. A contact type image sensor as claimed in claim 1, wherein a length of said sensor chip is 220 mm or more.

11. A contact type image sensor as claimed in claim 10, wherein said supporting substrate is a ceramic circuit board.
